(19) United States
(12) Patent Application Publication
(10) Pub. No.: US 2022/0269795 A1
(43) Pub. Date: Aug. 25, 2022

(54) METHODS AND SYSTEMS TO AUTOMATICALLY GENERATE NATURAL LANGUAGE INSIGHTS FOR SOFTWARE COMPONENTS FROM CALCULATED SCORES

(71) Applicant: Open Weaver Inc., Miami, FL (US)

(72) Inventors: Ashok Balasubramanian, Chennai (IN); Karthikeyan Krishnaswamy Raja, Chennai (IN); Meenakshisundaram Chinnappan, Chennai (IN); Lakshmipathy Ganesh Eswaran, Chennai (IN); John Hansel, Chennai (IN)

(73) Assignee: Open Weaver Inc., Miami, FL (US)

(21) Appl. No.: 17/679,602

(22) Filed: Feb. 24, 2022

Related U.S. Application Data
(60) Provisional application No. 63/153,226, filed on Feb. 24, 2021.

(51) Int. Cl. G06F 21/57; G06N 5/02; G06F 40/166; G06F 40/279; G06F 40/30

(52) U.S. Cl. CPC G06F 21/577; G06N 5/022; G06F 40/166; G06F 40/279; G06F 40/30; G06F 2221/033

(57) ABSTRACT

Systems and methods for automatically generating natural language insights for software components from calculated scores are provided. An exemplary method includes identifying the software component uniquely, identifying sources to gather information for the software component, accessing information for the software component from the identified sources, and tabulating the retrieved information. Support summary insights are generated based on the trained catalog of the natural language terms and the tabulated information and indicate a quality of support for the software component. Quality summary insights are generated based on the trained catalog of the natural language terms and the tabulated information and indicate about a quality of the software component. Security summary insights are generated based on the trained catalog of the natural language terms and the tabulated information of the software component and indicate how secure the software component is.

### CROSS-REFERENCE TO RELATED PATENT APPLICATION

This application claims the benefit of and priority to U.S. Provisional Patent Application No. 63/153,226 filed Feb. 24, 2021, the entire disclosure of which is incorporated by reference herein.

### TECHNICAL FIELD

The present disclosure relates to methods and systems for searching of software components and generating natural language insights for the software component.

### BACKGROUND

There are over 40 million software components available in the public domain. They are changing every minute with new software components being added and existing software components being updated. Software components also belong to various categories of source code, packages, cloud-based APIs, and other forms of libraries.

Across these diverse types of software components, their fit for use is measured by different metrics like software code quality, vulnerabilities reported, size of code, Q&A available, support response time, releases, popularity, and other measures. Given this volume and complexity of metrics and categories, many developers find it difficult to compare and decide on which software component to choose and use in their applications.

### SUMMARY

There is provided, in accordance with an embodiment of the present disclosure a method and system to automatically generate natural language insights for software components. The method comprises submitting details of software components for which natural language insights are required. The method further comprises identifying the software component uniquely. Further, the method comprises identifying a plurality of sources to gather information for a software component. Further, information for the software component is accessed from the identified plurality of sources. Thereafter, the retrieved information is tabulated. Further, support summary insights is generated based on the trained catalog of the natural language terms and the tabulated information, wherein the support summary insights indicate about a quality of support for the software component. Thereafter, quality summary insights is generated based on the trained catalog of the natural language terms and the tabulated information, wherein the quality summary insights indicate about a quality of the software component. Further, the security summary insights is generated based on the trained catalog of the natural language terms and the tabulated information of the software component, wherein the security summary insights indicate how secure the software component is.

In some embodiments, the method comprises accepting request to generate insights of software components. Further, descriptors of the software component with qualifiers indicating source of the software components is accepted if desired by the user and user preferences and context of the software component implementation. Also, interaction with an external system can be done instead of the user as and when required.

In further embodiments, software component requested by the user is identified and machine learning techniques is used to shortlist the source of the software component based on the user preferences and context if the software component is present across multiple providers.

In some embodiments, the plurality of sources include public code repositories and website of the software component provider. In some embodiments, machine learning and natural language generation techniques is used to provide a context match of the software component and the user or system provided context. Further, the support summary service is called to generate support summary insights, the quality summary service is called to generate quality summary insights, and the security summary service is called to generate security summary insights. Further, an insight widget comprising the support summary insights, the quality summary insights, and the security summary insights may be generated.

In some embodiments, machine learning and natural language generation techniques is used to generate the support summary insights support information of the software component is looked up. The support information include number of stars or an equivalent rating score from the software component provider, the number of forks or an equivalent download score from the software component provider, the number of releases of the software components and its recency and the sentiment score from software reviews across software component review sites and question and answer (Q&A) sites. Further, the number of stars or an equivalent rating score, the number of forks or an equivalent download score, the number of releases of the software components and its recency and the sentiment score is compared with other similar software components and natural language generation is used to describe the score to the user.

In yet another embodiments, machine learning and natural language generation techniques is used to generate the quality summary insights. Further, the quality information of the software component is looked up wherein the quality information include number of bugs and number of issues highlighted in code quality scan of the software component. Based on the quality information, a quality score for the software component is generated. Further, the quality score is compared with other similar software components and natural language generation is leveraged to describe the quality score to the user.

In some embodiments, machine learning and natural language generation techniques is used to generate the security summary insights and looking up the security information of the software component wherein the security information include number of vulnerabilities reported, and number of issues highlighted in the code security scan of the software component. Based on the security information, a security score for the software component is generated. Further, the security score is compared with other similar software components and natural language generation is leveraged to describe the security score to the user.

In some embodiments, using machine learning techniques is used to train a catalog of natural language terms related to software fit, quality, support, and security and providing a lookup service to support summary service, quality summary service, and security summary service.

In yet another embodiment, component details of software component that are available in public sources are processed. The public sources include Q&A websites, review websites, common vulnerabilities and exposures (CVE), national vulnerability database (NVD) and other vulnerability information providers, GitHub, GitLab, BitBucket, SourceForge, Microsoft Azure, Amazon Web Services, Google Compute Platform, RapidAPI, node package manager (NPM), python package index (PyPi), product details page of the software component provider, Wikipedia etc.

One aspect includes a system for automatically generating natural language insights for software components, the system comprising: one or more processors and memory storing instructions that, when executed by the one or more processors, cause the one or more processors to perform operations a web graphical user interface (GUI) portal to input details of a software component; receiving details of a software component for which insights is to be generated; identifying, based on the details, the software component; identifying a plurality of sources to gather information for the software component; accessing the identified plurality of sources to retrieve the information for the software component; tabulating the retrieved information; training a catalog of natural language terms related to the software component; generating support summary insights for the software component in natural language based on the trained catalog of the natural language terms and the tabulated information, wherein the support summary insights indicate a quality of support for the software component; generating quality summary insights for the software component in natural language based on the trained catalog of the natural language terms and the tabulated information, wherein the quality summary insights indicate a quality of the software component; generating security summary insights for the software component in natural language based on the trained catalog of the natural language terms and the tabulated information of the software component, wherein the security summary insights indicate how secure the software component is; and providing an overall summary based on the support, quality, and security summary insights.

In some embodiments, the operations further comprise receiving a request to generate insights of software components; receiving descriptors of the software component with qualifiers indicating a source of the software components if desired by the user; receiving user preferences and context of the software component implementation; and communicating with an external system instead of the user when required.

In some embodiments, the operations further comprise providing, based on results a machine learning model, a list including the source of the software component based on the user preferences and context if the software component is present across multiple providers.

In some embodiments, the plurality of sources include public sources and website of the software component provider, and wherein the public sources include one or more of question and answer (Q&A) sites, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia.

In some embodiments, the operations further comprise providing, based on results of a machine learning model, a context match of the software component and the user or system provided context, wherein the context match of the software component and the user or system provided context to installing or using as a service or using the source code or an activity that helps the user understand the overall fit of the software component; generating support summary insights, the quality summary insights, and the security summary insights; and generating an insight widget comprising the support summary insights, the quality summary insights, and the security summary insights.

In some embodiments, the operations further comprise generating, based on results of a machine learning model and natural language processing, the support summary insights; retrieving the support information of the software component, wherein the support information includes number of stars or an equivalent rating score from the software component provider, the number of forks or an equivalent download score from the software component provider, the number of releases of the software components and its recentness, and the sentiment score from software reviews across software component review sites and the Q&A sites; comparing the number of stars or an equivalent rating score, the number of forks or an equivalent download score, the number of releases of the software components and its recentness and the sentiment score with other similar software components; and providing, via natural language processing, the score to the user;

In some embodiments, the operations further comprise generating, based on results of a machine learning model and natural language processing, the quality summary insights; retrieving the quality information of the software component, wherein the quality information includes number of bugs and number of issues highlighted in code quality scan of the software component; determining a quality score based on the quality information; comparing the quality score with other similar software components; and providing, based on natural language processing, the quality score insights to the user.

In some embodiments, the operations further comprise generating, based on results of a machine learning model and natural language processing, the security summary insights; retrieving the security information of the software component, wherein the security information includes number of vulnerabilities reported, and number of issues highlighted in the code security scan of the software component; determining a security score based on the security information; comparing the security score with other similar software components; and providing, based on natural language processing, the security summary score to the user.

In some embodiments, the operations further comprise training, based on results of a machine learning model, a catalog of natural language terms related to software component's fit, quality, support, and security; and retrieving, based on the catalog, information for the support summary, the quality summary, or the security summary.

In some embodiments, the operations further comprise processing different software component details that are available in public sources, wherein the public sources include Q&A websites, review websites, common vulnerabilities and exposures (CVE), national vulnerability database (NVD) and other vulnerability information providers, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia; determining the uniform resource locators (URLs) of the public sources; and storing the URLs of the public sources into the file storage.

Another aspect is a method for automatically generating natural language insights for software components, the method comprising: receiving details of a software component for which insights is to be generated; identifying, based on the details, the software component; identifying a plurality of sources to gather information for the software component; accessing the identified plurality of sources to retrieve the information for the software component; tabulating the retrieved information; training a catalog of natural language terms related to the software component; generating support summary insights for the software component in natural language based on the trained catalog of the natural language terms and the tabulated information, wherein the support summary insights indicate a quality of support for the software component; generating quality summary insights for the software component in natural language based on the trained catalog of the natural language terms and the tabulated information, wherein the quality summary insights indicate a quality of the software component; generating security summary insights for the software component in natural language based on the trained catalog of the natural language terms and the tabulated information of the software component, wherein the security summary insights indicate how secure the software component is; and providing an overall summary based on the support, quality, and security summary insights.

In some embodiments, the method further comprises receiving a request to generate insights of software components; receiving descriptors of the software component with qualifiers indicating source of the software components if desired by the user and user preferences and context of the software component implementation; and communicating with an external system instead of the user when required.

In some embodiments, the method further comprises identifying the software component requested by the user; and providing, based on results of a machine learning model, a list including the source of the software component based on the user preferences and context if the software component is present across multiple providers.

In some embodiments, the plurality of sources include public code repositories and website of the software component provider.

In some embodiments, the method further comprises providing, based on results of a machine learning model and natural language processing, a context match of the software component and the user or system provided context, wherein the context match of the software component and the user or system provided context include installing or using as a service or using the source code or an activity that helps the user understand the overall fit of the software component; generating the support summary insights, quality summary insights, and the security summary insights; and generating an insight widget comprising the support summary insights, the quality summary insights, and the security summary insights.

In some embodiments, the method further comprises generating, based on results of a machine learning model and natural language processing, the support summary insights and looking up the support information of the software component, wherein the support information include number of stars or an equivalent rating score from the software component provider, the number of forks or an equivalent download score from the software component provider, the number of releases of the software components and its recentness and the sentiment score from software reviews across software component review sites and question and answer (Q&A) sites; comparing the number of stars or an equivalent rating score, the number of forks or an equivalent download score, the number of releases of the software components and its recentness and the sentiment score with other similar software components; and providing, based on natural language processing, the score to the user.

In some embodiments, the method further comprises generating, based on results of a machine learning model and natural language processing, the quality summary insights; retrieving the quality information of the software component, wherein the quality information include number of bugs and number of issues highlighted in code quality scan of the software component; determining a quality score based on the quality information; comparing the quality score with other similar software components; and providing, based on natural language processing, the quality score to the user.

In some embodiments, the method further comprises generating, based on results of a machine learning model and natural language processing, the security summary insights and looking up the security information of the software component, wherein the security information include number of vulnerabilities reported, and number of issues highlighted in the code security scan of the software component; determining a security score based on the security information; comparing the security score with other similar software components; and providing, based on natural language processing, the security score to the user.

In some embodiments, the method further comprises training, via a machine learning model, a catalog of natural language terms related to software fit, quality, support, and security; and retrieving, based on the catalog, information for the support summary, quality summary, and security summary.

In some embodiments, the method further comprises processing different software component details that are available in public sources, wherein the public sources include one or more of the Q&A websites, review websites, common vulnerabilities and exposures (CVE), national vulnerability database (NVD) and other vulnerability information providers, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia; determining uniform resource locators (URLs) of the public sources; and storing the URLs of the public sources in the file storage.

Another aspect is a computer program product for automatically generating natural language insights for software component, the computer program product comprising a processor and memory storing instructions thereon, wherein the instructions when executed by the processor causes the processor to: receive details of a software component for which insights is to be generated; identify, based on the details, the software component; identify a plurality of sources to gather information for the software component; access the identified plurality of sources to retrieve the information for the software component; tabulate the retrieved information; train a catalog of natural language terms related to the software component; generate support summary insights for the software component in natural language based on the trained catalog of the natural language terms and the tabulated information, wherein the support summary insights indicate about a quality of support for the software component; generate quality summary insights for the software component in natural language based on the trained catalog of the natural language terms and the tabulated information, wherein the quality summary insights indicate about a quality of the software component; generate security summary insights for the software component in natural language based on the trained catalog of the natural language terms and the tabulated information of the software component, wherein the security summary insights indicate how secure the software component is; and provide an overall summary based on the support, quality, and security summary insights.

### BRIEF DESCRIPTION OF THE DRAWINGS

FIG. 1 shows an example system architecture to automatically generate natural language insights for software components, in accordance with some embodiments.

FIG. 2 shows an example computer system for automatically generating natural language insights for software components, in accordance with some embodiments.

FIG. 3 shows the overall process flow of automatically generating natural language insights for software components from calculated scores, in accordance with some embodiments.

FIG. 4 shows an example method for generating natural language insights for the software component, in accordance with some embodiments.

FIG. 5 shows another example method for generating natural language insights for the software component, in accordance with some embodiments.

FIG. 6 shows yet another example method for generating natural language insights for the software component, in accordance with some embodiments.

FIG. 7 shows yet another example method for generating natural language insights for the software component, in accordance with some embodiments.

FIG. 8 shows an example natural language insights for a software component, in accordance with some embodiments.

FIG. 9 shows another process of automatically generating natural language insights for software components, in accordance with some embodiments.

Like reference numbers and designations in the various drawings indicate like elements.

Persons skilled in the art will appreciate that elements in the figures are illustrated for simplicity and clarity and may represent both hardware and software components of the system. Further, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

Exemplary embodiments now will be described. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

Not understanding the quality, security and support availability or the fitness of the software component to their context results in significant costs, reworks, software failures, and business downtime in addition to the time taken for manual review.

In order to enable a developer choose the right software component, the present subject matter generates software component specific natural language insights along with standardized software scores for various parameters. Thus, an easy-to-understand natural language-based description summary for different software components on standardized measures is generated.

Based on the natural language insights, the developers would be able to save considerable time in deciding which software component to use and can also avoid errors of choice and rework because of easy-to-understand summaries.

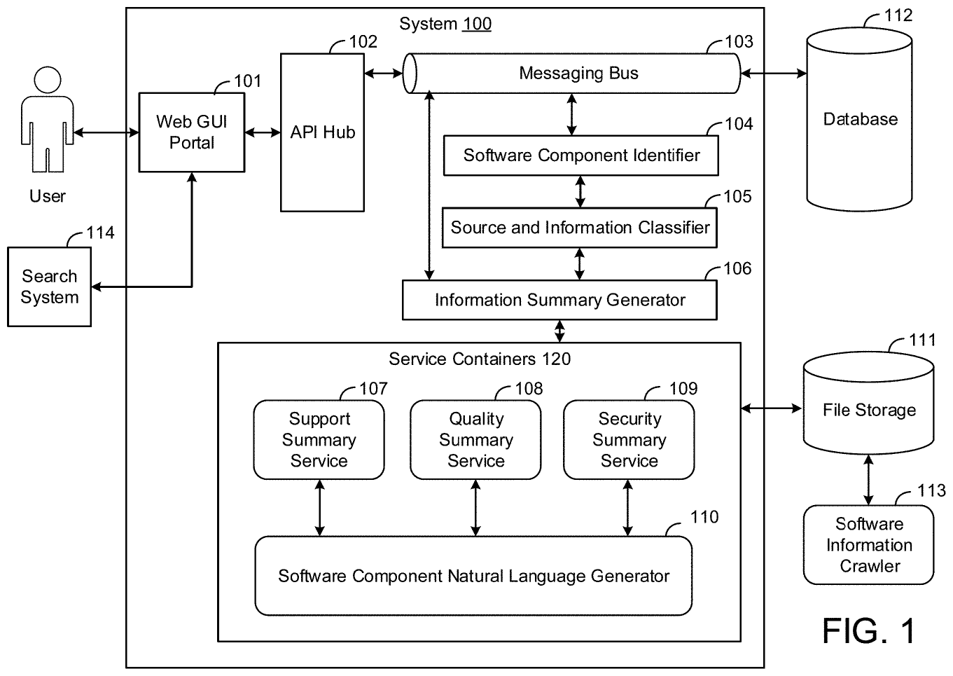

FIG. 1 shows an example system architecture to generate of natural language insights for software components, in accordance with some embodiments. Briefly, and as described in further detail below, the system 100 discloses a web graphical user interface (GUI) portal 101, application programming interface (API) hub 102, messaging bus 103, software component identifier 104, source and information classifier 105, and information summary generator 106. The system 100 includes service containers 120 which include support summary service 107, quality summary service 108, security summary service 109, and software component natural language generator 110. The system 100 also includes file storage 111, database 112, and software information crawler 113, which are a unique set of components to perform the task of automatically generate natural language insights for software components from Calculated Scores given the software components. The service containers 120 may include additional services that are not shown in FIG. 1.

In the embodiment shown in FIG. 1, the web GUI portal 101 has a user interface form for a user to interface with the system 100 for submitting different requests for generating natural language insights for the software components. The web GUI portal 101 may also be used for viewing the results. The web GUI portal 101 allows the user to submit requests for gaining insights on software components along with their preferences and context of information request and viewing the generated results. For submitting a new request, user is presented with a form to provide the software component names and descriptions that they would like to have more details on. The user may input details, descriptors, qualifiers which may be useful for identifying the software component and the sources of the software component. Alternatively, where automation is required, the web GUI portal 101 can also interact with an external system (e.g., the search system 114) to provide the same information that the user would have been provided.

The submitted request from web portal goes to the API hub 102 which acts as a gateway for accepting and transmitting all web service requests from the portal. The API hub 102 hosts the web services for taking the requests and creating request messages to be put into the messaging bus 103. The messaging bus 103 provides for event driven architecture thereby enabling long running processes to be decoupled from requesting system's calls. This decoupling will help the system to service the request and notify user once the entire process of generating details of the software component is completed. There are job listeners configured to listen to the messages in the messaging bus 103.

The software component identifier 104 identifies the software component requested by the user and uses machine learning techniques to shortlist the source of the software component based on the user preferences and context if the software component is present across multiple providers.

The source and information classifier identifies plurality of sources to gather information for the software component. The source and information classifier 105 identifies the plurality of sources of information based on the software component type for the different ratings. In an example, the plurality of different sources may be Q&A sites, public code repositories like, but not limiting to, GitHub, GitLab, BitBucket, SourceForge, cloud and API providers like, but not limiting to, Microsoft Azure, Amazon Web Services, Google Compute Platform, RapidAPI, software package managers like, but not limiting to, node package manager (NPM), python package index (PyPi) etc., public websites like, but not limiting to, the product details page of the software component provider, Wikipedia etc.

Thereafter, the software information crawler 113 accesses the identified plurality of sources to retrieve information for the software component. The information summary generator 106 anchors the retrieved information and tabulate the retrieved information. The information summary generator 106 uses machine learning and natural language generation techniques to provide a context match of the software component and the user or system provided context, such as but not limited to installing or using as a service or using the source code or an activity such as animation in a specific technology like JavaScript etc. This helps the user in understanding the overall fit to usability of the software component.

Based on the trained catalog of the natural language terms and the tabulated information, the support summary service 107 generates support summary insights of the software component in natural language, wherein the support summary insights indicate about a quality of support provided for the software component. Further, based on the trained catalog of the natural language terms and the tabulated information, the quality summary service 108 generates quality summary insights in natural language, wherein the quality summary insights indicate about a quality of the software component. Further, based on the trained catalog of the natural language terms and the tabulated information of the software component, the security summary service 109 generates security summary insights in natural language, wherein the security summary insights indicate how secure the software component is. Further, an insight widget comprising the support summary insights, the quality summary insights, and the security summary insights may be generated. The process is explained in detailed hereinafter.

In an example, the support summary service 107 looks up the support information of the software component such as the number of stars or an equivalent rating score from the software component provider, the number of forks or an equivalent download score from the software component provider, the number of releases of the software components and its recency and the sentiment score from software reviews across software component review sites and the Q&A sites. The support summary service 107 compares the number of stars or an equivalent rating score, the number of forks or an equivalent download score, the number of releases of the software components and its recency and the sentiment score with other similar software components and leverages natural language generation to describe the score to the user. A representative sample of the input for the Support Summary Service 107 is as follows:

```
Support:
{
scores: {
  _id: ‘django/django’,
  activityScore: 21.410646422612018,
  solutionScore: 12.616445689990922,
  sentimentScore: 50.17417644831503,
  userbaseScore: 14.02607937769633,
  socialScore: 98.22734793861432,
  popularityScore: 4.782178695123661,
  supportScore: 6.616342316825855,
  }
}
```

This representation data is processed by the support summary service 107 to generate a support summary for the software component.

The quality summary service 108 uses machine learning and natural language generation techniques to generate the quality summary insights. The quality summary service 108 looks up the quality information that include details, such as the number of bugs and number of issues highlighted in its code quality scan against quality best practices. Based on the quality information, a quality score is determined. The quality summary service 108 compares the quality score with other similar software components and leverages natural language generation to describe the quality summary insights to the user. An example sample of the input for the Quality Summary Service 108 is as follows:

```
Quality:
{
scores: {
  _id: ‘django/django’,
  qualityScore: 6.616342316825855,
  codeQualitySecurityDetails: {
    bugsScore: 10,
    codesmellScore: 10,
    bugsCountBlocker: 5,
    bugsCountCritical: 0,
    bugsCountMajor: 110,
    bugsCountMinor: 73,
    codesmellCountBlocker: 16,
    codesmellCountCritical: 2181,
    codesmellCountMajor: 542,
    codesmellCountMinor: 526,
    }
  }
}
```

This representation data is processed by the quality summary service 108 to generate a quality summary for the software component.

The security summary service 109 uses machine learning and natural language generation techniques to generate the security summary insights. The security summary service 109 looks up the security information of the software component such as the number of vulnerabilities reported, and number of issues highlighted in its code security scan against security best practices. Based on the security information, a security score is determined. The security summary service 109 compares the security score with other similar software components and leverages natural language generation to describe the security score to the user. A sample representation of the input for the Security Summary Service 109 is as follows:

```
Security:
{
scores: {
  _id: ‘django/django’,
  qualityScore: 6.616342316825855,
  codeQualitySecurityDetails: {
    bugsScore: 10,
    codesmellScore: 10,
    bugsCountBlocker: 5,
    bugsCountCritical: 0,
    bugsCountMajor: 110,
    bugsCountMinor: 73,
    codesmellCountBlocker: 16,
    codesmellCountCritical: 2181,
    codesmellCountMajor: 542,
    codesmellCountMinor: 526,
    }
  }
}
```

This representation data is processed by the security summary service 109 to generate a Security summary for the software component.

The software component natural language generator 110 uses machine learning techniques to train a catalog of natural language terms related to software fit, quality, support, and security. The software component natural language generator 110 provides this lookup service to support summary service 107, quality summary service 108, and security summary service 109.

The file storage 111 is used to store document type of data, source code files, documents, readme files, installation guides, marketing collateral, user guides, neural network models etc.

The database 112 is relation database management system (RDBMS) database like My SQL to store all meta-data pertaining to the requests received from the user, external system, messaging bus, request processor and from other system components described above. The meta-data includes details of every request to identify who submitted it, requested details to track the progress as the System processes the request through its different tasks. The status of each execution step in complete process is stored in this database to track and notify the system on completion.

The software information crawler 113 processes different software component details that are available in public sources such as, on Q&A websites, review websites, CVE, NVD and other vulnerability information providers, public code repositories like, but not limiting to, GitHub, GitLab, BitBucket, SourceForge, Cloud and API providers like, but not limiting to, Microsoft Azure, Amazon Web Services, Google Compute Platform, RapidAPI, software package managers like, but not limiting to, NPM, PyPi etc., public websites like, but not limiting to, the product details page of the software component provider, Wikipedia etc. The software information crawler 113 determines uniform resource locators (URLs) of the sources and stores the details of different unique URLs of the information resources into the file storage.

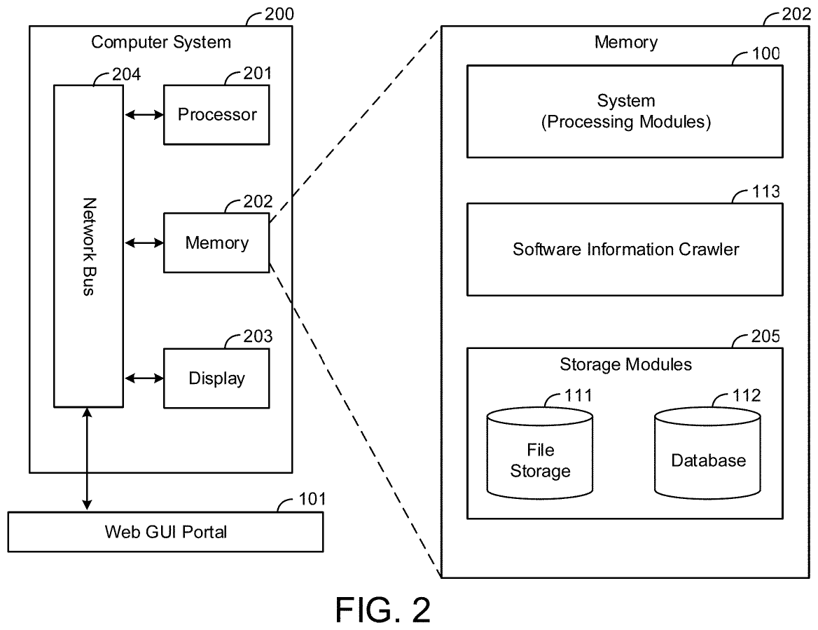

FIG. 2 shows an example computer system for automatically generating natural language insights for software components, in accordance with some embodiments. The computer system may include a processor 201, a memory 202, a display 203, a network Bus 204, and other input/output like a microphone, speaker, wireless card, etc. To generate natural language insights for software components from calculated scores, the processing modules for the system 100 performs the steps as explained above. The file storage 111, database 112, software information crawler 113, web GUI portal 101 are stored in the memory 202 which provides the necessary machine instructions to the processor 201 to perform the executions for automatically generating natural language insights for software components from calculated scores. In embodiments, the processor 201 controls the overall operation of the system and managing the communication between the components through the network bus 204. The memory 202 holds the automatically generated natural language insights for software components from calculated scores system code, data, and instructions of the system processing modules 100 and of diverse types of the non-volatile memory and volatile memory.

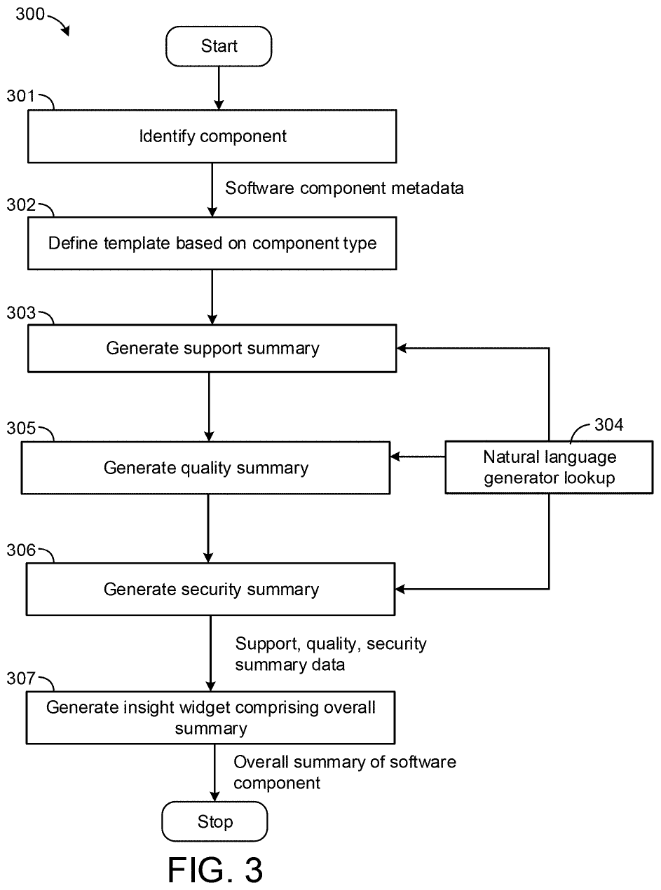

FIG. 3 shows the overall process 300 of automatically generating natural language insights for software components from calculated scores, in accordance with some embodiments. It should be understood that the method steps are shown as a reference only and sequence of the method steps should not be construed as limitation. The method steps can include any additional steps in any order. Although, the method 300 may be implemented in any system, the example method 300 is provided in reference to the system 100 for ease of explanation.

In step 301, the software component is identified based on the inputs provided to a system, such as the system 100. In an example, the inputs may be provided using the web GUI portal. In step 302 based on the software component type, plurality of sources for acquiring information of the software component are identified, and the natural language generation template is identified. Further, a catalog of natural language terms related to the software component may be trained. In step 303, natural language-based support summary insight is generated. The support summary insights indicate about a quality of support for the software component. In step 305, natural language-based quality summary insight is generated. The quality summary insights indicate about a quality of the software component. In step 306, natural language-based security summary insight is generated. The security summary insights indicate how secure the software component is. In step 304, a natural language generator lookup provides software component specific natural language lookup to steps 303, 305, and 306. In step 307 all the information is collated into the insight widget and sent to the web GUI or a calling system. The insight widget may be displayed in the web GUI.

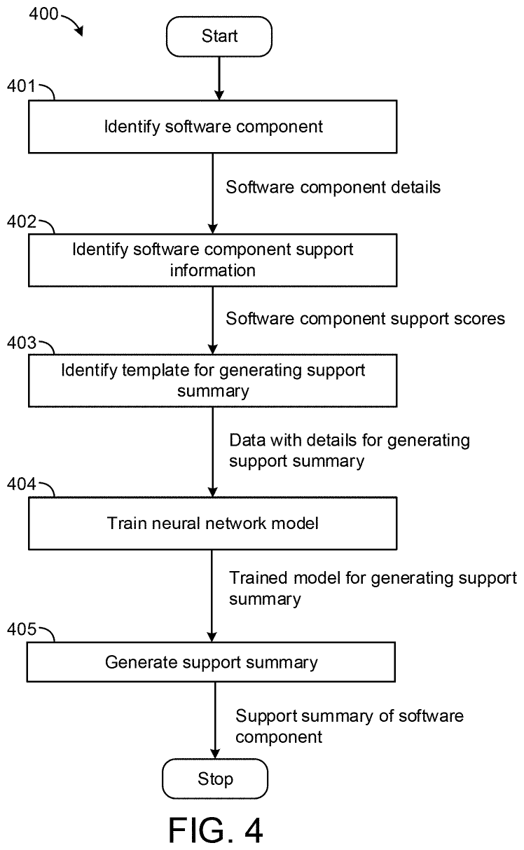

FIG. 4 shows an example method 400 for generating natural language insights for the software component, in accordance with some embodiments. It should be understood that the method steps are shown as a reference only and sequence of the method steps should not be construed as limitation. The method steps can include any additional steps in any order. Although, the method 400 may be implemented in any system, the example method 400 is provided in reference to the system 100 for ease of explanation.

In step 401, the input software component is identified based on the inputs provide by a user. Further, details of the input software component is gathered. In step 402, software component's support information and its information sources are identified. Based on the component's support information and its information sources, a support score of the software component is determined. The support score for software components is then passed on to the next step 403. In step 403, the templates are identified for generating the support summary. The data with details of support summary is collected and sent to the next step 404. The step 404 is the neural network training for generating support summary. The neural network is trained with the details of software components and support summary. In step 405, the neural network model trained in step 404 generates a natural language summary as support summary of a software component.

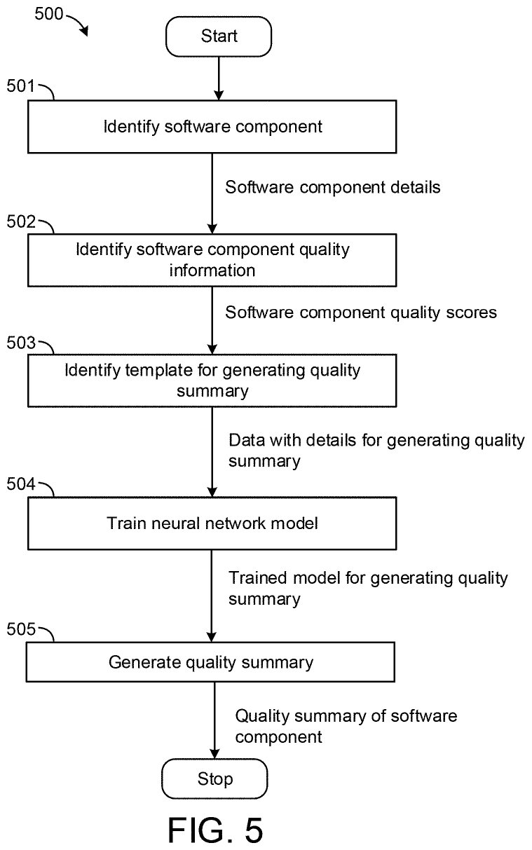

FIG. 5 shows another example method 500 for generating natural language insights for the software component, in accordance with some embodiments. It should be understood that the method steps are shown as a reference only and sequence of the method steps should not be construed as limitation. The method steps can include any additional steps in any order. Although, the method 500 may be implemented in any system, the example method 500 is provided in reference to the system 100 for ease of explanation.

In step 501, the input software component is identified, and details are gathered. In step 502, software component's quality information and its information sources are identified. The quality scores for software components are passed on to the next step 503. In step 503, the templates are identified for generating the quality information. The data with details of quality information is collected and sent to the next step 504. The step 504 is the neural network training for generating quality summary wherein the neural network is trained with the details of software components and quality information. In step 505, the neural network model trained in step 504 generates a Natural language summary as quality summary of a software component.

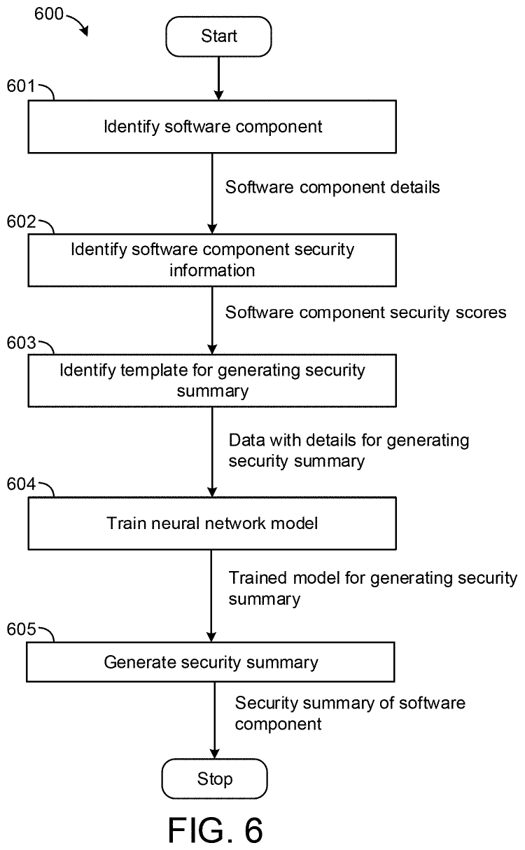

FIG. 6 shows a process 600 of generating security information for software components, in accordance with some embodiments. It should be understood that the method steps are shown as a reference only and sequence of the method steps should not be construed as limitation. The method steps can include any additional steps in any order. Although, the method 600 may be implemented in any system, the example method 600 is provided in reference to the system 100 for ease of explanation.

In step 601, the input software component is identified, and details are gathered. In step 602, software component's security information and its information sources are identified and based on the security information a security score is generated. The security score for software components are then passed on to the next step 603. In step 603, the templates are identified for generating the security information. The data with details of security information is collected and sent to the next step 604. The step 604 is the neural network training for generating security summary. The neural network is trained with the details of software components and security information. In step 605, the neural network model trained in the step 604 generates a natural language summary as security summary of a software component.

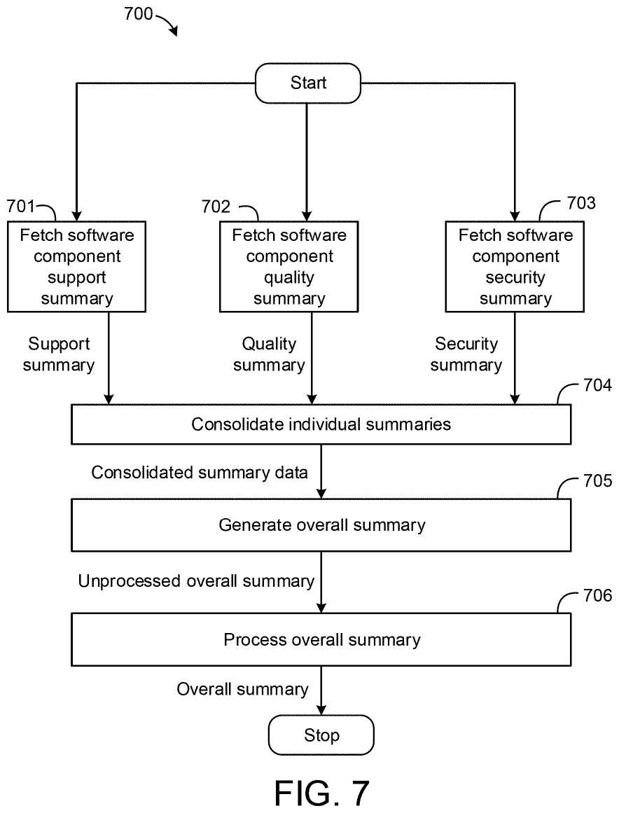

FIG. 7 shows yet another example method 700 for generating natural language insights for the software component, in accordance with some embodiments. It should be understood that the method steps are shown as a reference only and sequence of the method steps should not be construed as limitation. The method steps can include any additional steps in any order. Although, the method 700 may be implemented in any system, the example method 700 is provided in reference to the system 100 for ease of explanation.

In step 701, the software component support summary generated in step 405 is fetched. In step 702, the software component quality summary generated in step 505 is fetched. In step 703, the software component security summary generated in the step 605 is fetched. In step 704, the individual summaries are obtained from steps 701, 702, 703 are consolidated and fed to next step 705 to generate the overall summary. In step 706, the consolidated summaries obtained from step 705 are processed using natural language summary generation techniques making use of machine learning to generate a final overall summary. The overall summary generated in step 706 is collated into the insight widget and sent to the web GUI or a calling system.

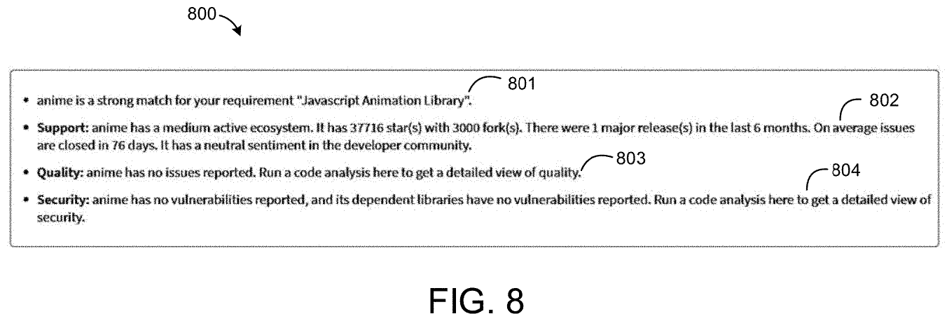

FIG. 8 shows an example widget 800 including example natural language insights for a software component, in accordance with some embodiments. In an example, the widget 800 showing support summary 802, quality summary 803, and security summary 804 is shown for the software component. Further, a quick summary 801 for the software component is provided.

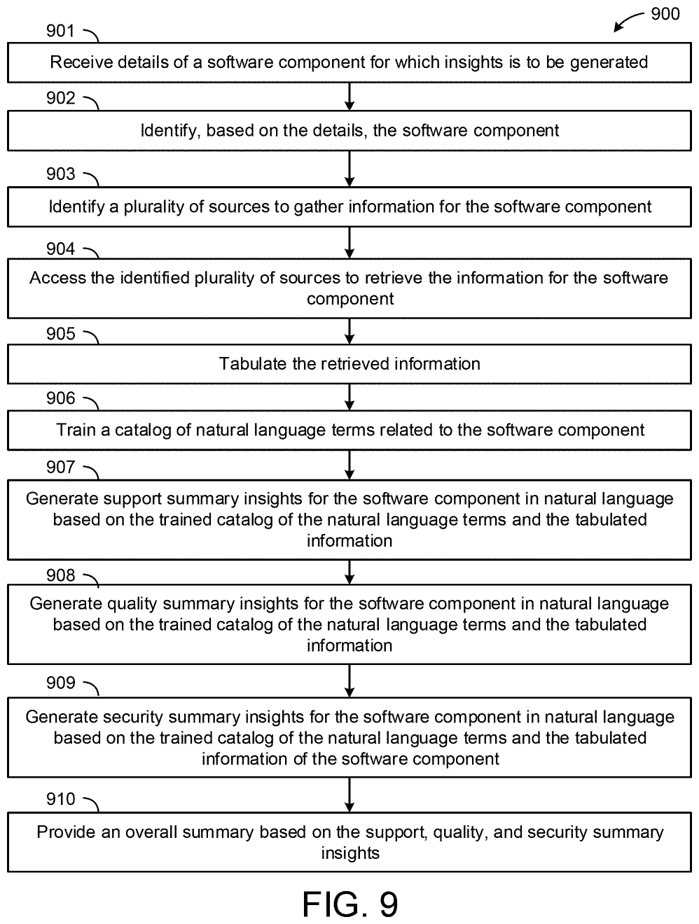

FIG. 9 shows a process 900 that can be performed by a computer program product for automated scoring of ecosystem activity for software projects. Process 900 can be performed by one or more components of system 100 as previously described. The computer program product for automated software natural language documentation comprises a processor and memory storing instructions. The instructions when executed by the processor causes the processor to perform multiple steps. The processor receives details of a software component for which insights is to be generated (step 901) and identifies, based on the details, the software component (step 902). The processor identifies a plurality of sources to gather information for the software component (step 903) and accesses the identified plurality of sources to retrieve the information for the software component (step 904). The processor tabulates the retrieved information (step 905) and trains a catalog of natural language terms related to the software component (step 906). The processor generates support summary insights for the software component in natural language based on the trained catalog of the natural language terms and the tabulated information, the support summary insights indicating about a quality of support for the software component (step 907). The processor generates quality summary insights for the software component in natural language based on the trained catalog of the natural language terms and the tabulated information, the quality summary insights indicating about a quality of the software component (step 908). The processor generates security summary insights for the software component in natural language based on the trained catalog of the natural language terms and the tabulated information of the software component, the security summary insights indicating how secure the software component is (step 909). The processor provides an overall summary based on the support, quality, and security summary insights (step 910).

As will be appreciated by one of skill in the art, the present disclosure may be embodied as a method and system. Accordingly, the present disclosure may take the form of an entirely hardware embodiment, a software embodiment or an embodiment combining software and hardware aspects. It will be understood that the functions of any of the units as described above can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts performed by any of the units as described above.

Instructions may also be stored in a computer-readable memory that can direct a computer or other programmable data processing apparatus to function in a particular manner, such that the instructions stored in the computer-readable memory produce an article of manufacture including instruction means which implement the function/act performed by any of the units as described above.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts performed by any of the units as described above.

In the specification, there has been disclosed exemplary embodiments of the disclosure. Although specific terms are employed, they are used in a generic and descriptive sense only and not for purposes of limitation of the scope of the disclosure.

What is claimed is:

1. A system for automatically generating natural language insights for software components, the system comprising:
one or more processors and memory storing instructions that, when executed by the one or more processors, cause the one or more processors to perform operations comprising:
receiving details of a software component for which insights is to be generated;
identifying, based on the details, the software component;
identifying a plurality of sources to gather information for the software component;
accessing the identified plurality of sources to retrieve the information for the software component;
tabulating the retrieved information;
training a catalog of natural language terms related to the software component;
generating support summary insights for the software component in natural language based on the trained catalog of the natural language terms and the tabulated information, wherein the support summary insights indicate a quality of support for the software component;
generating quality summary insights for the software component in natural language based on the trained catalog of the natural language terms and the tabulated information, wherein the quality summary insights indicate a quality of the software component;
generating security summary insights for the software component in natural language based on the trained catalog of the natural language terms and the tabulated information of the software component, wherein the security summary insights indicate how secure the software component is; and
providing an overall summary based on the support, quality, and security summary insights.

2. The system of claim 1, the operations further comprising:
receiving a request to generate insights of software components;
receiving descriptors of the software component with qualifiers indicating a source of the software components if desired by the user;
receiving user preferences and context of the software component implementation; and
communicating with an external system instead of the user when required.

3. The system of claim 1, the operations further comprising:
providing, based on results a machine learning model, a list including the source of the software component based on the user preferences and context if the software component is present across multiple providers.

4. The system of claim 1, wherein the plurality of sources include public sources and website of the software component provider, and wherein the public sources include one or more of question and answer (Q&A) sites, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia.

5. The system of claim 1, the operations further comprising:
providing, based on results of a machine learning model, a context match of the software component and the user or system provided context, wherein the context match of the software component and the user or system provided context to installing or using as a service or using the source code or an activity that helps the user understand the overall fit of the software component;
generating support summary insights, the quality summary insights, and the security summary insights; and
generating an insight widget comprising the support summary insights, the quality summary insights, and the security summary insights.

6. The system of claim 1, the operations further comprising:
generating, based on results of a machine learning model and natural language processing, the support summary insights;
retrieving the support information of the software component, wherein the support information includes number of stars or an equivalent rating score from the software component provider, the number of forks or an equivalent download score from the software component provider, the number of releases of the software components and its recentness, and the sentiment score from software reviews across software component review sites and the Q&A sites;
comparing the number of stars or an equivalent rating score, the number of forks or an equivalent download score, the number of releases of the software components and its recentness and the sentiment score with other similar software components; and
providing, via natural language processing, the score to the user;

7. The system of claim 1, the operations further comprising:
generating, based on results of a machine learning model and natural language processing, the quality summary insights;
retrieving the quality information of the software component, wherein the quality information includes number of bugs and number of issues highlighted in code quality scan of the software component;
determining a quality score based on the quality information;
comparing the quality score with other similar software components; and
providing, based on natural language processing, the quality score insights to the user.

8. The system of claim 1, the operations further comprising:
generating, based on results of a machine learning model and natural language processing, the security summary insights;
retrieving the security information of the software component, wherein the security information includes number of vulnerabilities reported, and number of issues highlighted in the code security scan of the software component;
determining a security score based on the security information;
comparing the security score with other similar software components; and
providing, based on natural language processing, the security summary score to the user.

9. The system of claim 1, the operations further comprising
training, based on results of a machine learning model, a catalog of natural language terms related to software component's fit, quality, support, and security; and
retrieving, based on the catalog, information for the support summary, the quality summary, or the security summary.

10. The system of claim 1, the operations further comprising:
processing different software component details that are available in public sources, wherein the public sources include Q&A websites, review websites, common vulnerabilities and exposures (CVE), national vulnerability database (NVD) and other vulnerability information providers, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia;
determining the uniform resource locators (URLs) of the public sources; and
storing the URLs of the public sources into the file storage.

11. A method for automatically generating natural language insights for software components, the method comprising:
receiving details of a software component for which insights is to be generated;
identifying, based on the details, the software component;
identifying a plurality of sources to gather information for the software component;
accessing the identified plurality of sources to retrieve the information for the software component;
tabulating the retrieved information;
training a catalog of natural language terms related to the software component;
generating support summary insights for the software component in natural language based on the trained catalog of the natural language terms and the tabulated information, wherein the support summary insights indicate a quality of support for the software component;
generating quality summary insights for the software component in natural language based on the trained catalog of the natural language terms and the tabulated information, wherein the quality summary insights indicate a quality of the software component;
generating security summary insights for the software component in natural language based on the trained catalog of the natural language terms and the tabulated information of the software component, wherein the security summary insights indicate how secure the software component is; and
providing an overall summary based on the support, quality, and security summary insights.

12. The method of claim 11, further comprising:
receiving a request to generate insights of software components;
receiving descriptors of the software component with qualifiers indicating source of the software components if desired by the user and user preferences and context of the software component implementation; and
communicating with an external system instead of the user when required.

13. The method of claim 11, further comprising:
identifying the software component requested by the user; and
providing, based on results of a machine learning model, a list including the source of the software component based on the user preferences and context if the software component is present across multiple providers.

14. The method of claim 11, wherein the plurality of sources include public code repositories and website of the software component provider.

15. The method of claim 11, further comprising:
providing, based on results of a machine learning model and natural language processing, a context match of the software component and the user or system provided context, wherein the context match of the software component and the user or system provided context include installing or using as a service or using the source code or an activity that helps the user understand the overall fit of the software component;
generating the support summary insights, quality summary insights, and the security summary insights; and
generating an insight widget comprising the support summary insights, the quality summary insights, and the security summary insights.

16. The method of claim 11, further comprising:
generating, based on results of a machine learning model and natural language processing, the support summary insights and looking up the support information of the software component, wherein the support information include number of stars or an equivalent rating score from the software component provider, the number of forks or an equivalent download score from the software component provider, the number of releases of the software components and its recentness and the sentiment score from software reviews across software component review sites and question and answer (Q&A) sites;
comparing the number of stars or an equivalent rating score, the number of forks or an equivalent download score, the number of releases of the software components and its recentness and the sentiment score with other similar software components; and
providing, based on natural language processing, the score to the user.

17. The method of claim 11, further comprising:
generating, based on results of a machine learning model and natural language processing, the quality summary insights;
retrieving the quality information of the software component, wherein the quality information include number of bugs and number of issues highlighted in code quality scan of the software component;
determining a quality score based on the quality information;
comparing the quality score with other similar software components; and
providing, based on natural language processing, the quality score to the user.

18. The method of claim 11, further comprising:
generating, based on results of a machine learning model and natural language processing, the security summary insights and looking up the security information of the software component, wherein the security information include number of vulnerabilities reported, and number of issues highlighted in the code security scan of the software component;
determining a security score based on the security information;
comparing the security score with other similar software components; and
providing, based on natural language processing, the security score to the user.

19. The method of claim 11, further comprising:
training, via a machine learning model, a catalog of natural language terms related to software fit, quality, support, and security; and
retrieving, based on the catalog, information for the support summary, quality summary, and security summary.

20. The method of claim 11, further comprising:
processing different software component details that are available in public sources, wherein the public sources include one or more of the Q&A websites, review websites, common vulnerabilities and exposures (CVE), national vulnerability database (NVD) and other vulnerability information providers, GitHub, GitLab, BitBucket, SourceForge, Microsoft Azure, Amazon Web Services, Google Compute Platform, RapidAPI, node package manager (NPM), python package index (PyPi), product details page of the software component provider, or Wikipedia;
determining uniform resource locators (URLs) of the public sources; and
storing the URLs of the public sources in the file storage.

21. A computer program product for automatically generating natural language insights for software component, the computer program product comprising a processor and memory storing instructions thereon, wherein the instructions when executed by the processor cause the processor to:
receive details of a software component for which insights is to be generated;
identify, based on the details, the software component;
identify a plurality of sources to gather information for the software component;
access the identified plurality of sources to retrieve the information for the software component;
tabulate the retrieved information;
train a catalog of natural language terms related to the software component;
generate support summary insights for the software component in natural language based on the trained catalog of the natural language terms and the tabulated information, wherein the support summary insights indicate about a quality of support for the software component;
generate quality summary insights for the software component in natural language based on the trained catalog of the natural language terms and the tabulated information, wherein the quality summary insights indicate about a quality of the software component;
generate security summary insights for the software component in natural language based on the trained catalog of the natural language terms and the tabulated information of the software component, wherein the security summary insights indicate how secure the software component is; and
provide an overall summary based on the support, quality, and security summary insights.
